(19) United States
(12) Patent Application Publication
(10) Pub. No.: US 2002/0060731 A1
(43) Pub. Date: May 23, 2002

(54) Dry gray-scale image processor

(76) Inventor: Tadashi Iwasa, Osaka-shi (JP)

Correspondence Address: HARNESS, DICKEY & PIERCE, P.L.C., P.O. BOX 828, BLOOMFIELD HILLS, MI, 48303, US

(21) Appl. No.: 09/924,892

(22) Filed: Aug. 8, 2001

(30) Foreign Application Priority Data
Nov. 22, 2000 (JP) 2000-356217

(51) Int. Cl. B41J 2/435; G03C 5/16

(52) U.S. Cl. 347/228; 430/350

(57) ABSTRACT

A dry gray-scale image processor can be made small and light, and the work area and space required by the processor can be used more efficiently. The dry gray-scale image processor extracts unexposed films one by one and carries them to an exposure unit, radiates a laser beam comprising an image data signal onto the film as it passes said exposure unit, and develops the exposed film by heating at a heating unit. The interval between an exposure position of the exposure unit and a heat start position of the heating unit is shorter than the length of the film in the delivery direction, and the processes of exposure and heating can be performed in parallel simultaneously.

### BACKGROUND OF THE INVENTION

1. Field of the Invention

The present invention relates to a dry gray-scale image processor which photographs an image data signal, obtained for example by X-ray CT and the like, onto a film, and more particularly relates to the dry gray-scale image processor which can be made small and light.

2. Related Art

Conventionally, an X-ray CT, a tracking-type nuclear magnetic resonance imaging tomography apparatus (MRI), and a digital X-ray scanning apparatus (DSA) and the like are used to obtain gray-scale images for medical examinations. The gray-scale image obtained by these apparatuses is transmitted via a network, such as the example shown in FIG. 4, from an MRI 1 and a CT 2 to a gray-scale image processor 3 known as a laser imager, which obtains a photograph from the gray-scale image.

The gray-scale image processor 3 decomposes the image into pixels and converts data of the digital image having the continuous tonality of the image to a chronologically continuous electrical signal. A semiconductor laser using a direct modulation system radiates the electrical signal onto a silver halide photosensitive film thereby obtaining a photograph.

This type of conventional gray-scale image processor 3 uses a so-called wet photograph method, wherein the film which has been exposed to the laser beam is passed through a film processing machine. In a wet gray-scale image processor, the film which has been exposed to the laser beam is usually accommodated in a collecting tray, and the collecting tray is carried to a film processing room where the film is developed.

A dry gray-scale image processor, which can develop the film in a single process and does not require developing solution, has recently been proposed. As for example shown in FIG. 5, according to the constitution of the dry gray-scale image processor, a special film for dry use is exposed to light at an unillustrated exposure section, the exposed film 4 is developed by heating, and the developed film 4a is thereafter discharged. In order to the exposed film 4 from being damaged by sliding during the heating process, the exposed film 4 is firmly attached to a heating drum 5 and heated while it is being carried thereon.

A plurality of heaters 6 are provided inside the heating drum 5 in order to maintain a uniform heating temperature. Furthermore, a great number of rollers 7 are provided at an appropriate pitch on the outside of the heating drum 5 in order to keep the exposed film 4 firmly attached thereto.

However, the conventional dry gray-scale image processor mentioned above has a drawback of being inconvenient for miniturization, since the processes of exposure and heating are completely separate, increasing the length of the carrying path of the film, etc.

Further, since the entire surface of the exposed film 4 is wound around the heating drum 5 and heated simultaneously, it is difficult to adjust the temperature of the heating drum 5 in order to prevent undesired variations in the development of the exposed film 4. That is, since the amount of heat applied to the exposed film 4 is itself the cause of such variations, the temperature must be controlled so that the entire surface of the heating drum 5, which the exposed film 4 is attached to, has a uniform temperature, or a temperature which varies only within an extremely narrow range (generally ±0.2° C.). Additional problems are presented by the number and arrangement of the rollers 7 for attaching the entire surface of the exposed film 4 to the heating drum 5, in view of the fact that it is extremely difficult to provide a processor which can be used for films of different sizes when the number and arrangement of the rollers is fixed. Such drum-type methods heat the film from one side, making them less convenient than double-sided heating methods, since the film must be heated uniformly to its opposite side (back side).

### SUMMARY OF THE INVENTION

The present invention has been realized in view of the problems described above, and aims to provide a dry gray-scale image processor which can be made small and light, and can make more efficient use of the work area and space required by the processor while simplifying the adjustment of temperature during heating.

In order to achieve the above objects, a first aspect of the present invention comprises a dry gray-scale image processor which extracts unexposed films one by one and carries them to an exposure unit, radiates a laser beam comprising an image data signal onto the film as it passes the exposure unit, and develops the exposed film by heating it at a heating unit. The interval between an exposure position of the exposure unit and a heat start position of the heating unit is shorter than the length of the film in the delivery direction, and the exposure process and heating process are performed in parallel simultaneously.

According to the above dry gray-scale image processor, the interval between the exposure position and the heat start position is shorter than the length of the film in the delivery direction. Therefore, the carrying distance of the film can be shortened and the number of carrying rollers and the like can be reduced, enabling the processor to be made small and light.

A film passage should preferably be provided between heating blocks, which are arranged on either side of the film, making it possible to heat the film from both sides.

Preferably, the heating unit should be set so that the temperature distribution along the width of the film and the heating distance along the delivery direction of the film are uniform. In this case, since the heating quantity of the entire film is determined, by multiplying the heating temperature which is uniform along the width of the film, and the heating distance in the delivery direction, thereby, the temperature of the film can be controlled more simply compared with the case of unifying the temperature on all sides of the film.

In the dry gray-scale image processor described above, the film passage should preferably have a large curvature with respect to the emulsion face side of the film, making the emulsion face side of the film less likely to contact the film passage. In this case, the film passage should preferably comprise two fluororesin coated opposing faces having a constant width therebetween, preventing damage even when the emulsion face side of the film does contact the film passage.

In the dry gray-scale image processor described above, a density level detecting unit should preferably be provided near the exit of the heating unit, so that the exposure unit can be controlled by feedback. As a consequence, the density of the film images becomes constant, enabling superior images to be stably obtained.

In addition, flatness regain rollers should preferably be provided at the exit of the heating unit, with a cooling region therebetween. This makes it possible to prevent warping of the film due to heating.

### BRIEF DESCRIPTION OF THE DRAWINGS

FIG. 1 is a cross-sectional view of the schematic constitution of a dry gray-scale image processor according to a first em of this invention.

FIG. 2 is an enlarged view of the passage of film in the heating unit in FIG. 1.

FIG. 3A relates to a heater of the heating unit in FIG. 1, showing a front view of the constitution of the heater.

FIG. 3B relates to a heater of the heating unit in FIG. 1, showing temperature distribution characteristics in the axial direction.

FIG. 4 is a diagram showing one example of the constitution of a medical examination system which uses a dry gray-scale image processor.

FIG. 5 is a diagram showing one example of a heating section in a conventional dry grayscale image processor.

### DESCRIPTION OF THE PREFERRED EMBODIMENT

An embodiment of the dry gray-scale image processor according to the present invention will be explained based on the drawings.

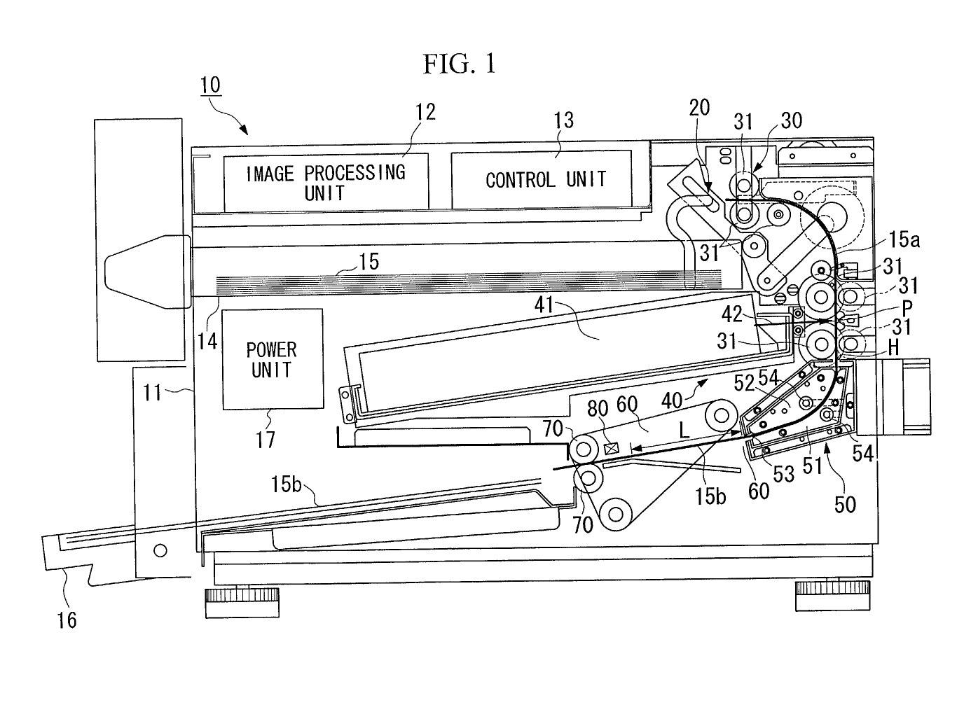

In FIG. 1, reference numeral 10 represents a dry gray-scale image processor (hereinafter “dry processor”) and reference numeral 11 represents a main body casing. The dry processor 10 comprises an image processing section 12 and a control section 13, which are provided at the top of the inside of the main body casing 11, and a freely removable film supply cassette 14, which is provided below the image processing section 12 and the control section 13. Sheets of unused silver halide photosensitive film (hereinafter “film”) 15 are stored in a pile inside the film supply cassette 14. A conventionally known pickup mechanism 20 extracts the film 15 one by one, and a carrying unit 30 delivers them to an exposure unit 40. The film 15 used here is a special-purpose film, which is suitable for exposure to a laser beam and heat-development.

The carrying unit 30 comprises a plurality of rollers 31, arranged at appropriate positions along the carrying path of the film 15. The carrying path of the film 15 is the path leading from the point where the film 15, which has been extracted from the film supply cassette 14 by the pickup mechanism 20, is exposed to light and developed by heating and stored in a film collection tray 16, explained later.

A high-power laser unit 41 is used as the exposure unit 40. The image processing section 12 decomposes image data, which has been input to the dry processor 10, into pixels and converts data of the digital image having the continuous tonality of the image to a chronologically continuous electrical signal. A laser unit 41, such as a semiconductor laser using a direct modulation system, radiates the electrical signal as a laser beam onto the film 15 at the point indicated by the arrow 42. Thus exposure position P represents the position at which the laser beam is radiated onto the film 15.

In this way, the laser beam is radiated onto the film 15 as it passes through the exposure unit 40, obtaining film which has been exposed to the image data (hereinafter “exposed film 15a”); the carrying unit 30 leads the exposed film 15a to a heating unit 50. As the exposed film 15a passes through the heating unit 50, it is heated on both sides by heating blocks 51 and 52, which are provided on both sides, and becomes developed film 15b. The developed film 15b passes a predetermined cooling region 60, which is provided immediately after the heating unit 50, and passes between flatness regain rollers 70 and is stored in the film collection tray 16. Therefore, the exposed film 15a enters the heating unit 50 at heat start position H.

The film collection tray 16 is provided below the film supply cassette 14, and can be freely attached and removed to/from the main body casing 11. A power section 17 is provided above the film collection tray 16.

In this way, the dry processor 10 of the present invention performs dry development processing wherein the unexposed films 15 are extracted one by one from the film supply cassette 14 by the pickup mechanism 20 and carried to the exposure unit 40; a laser beam 42 comprising an image data signal is radiated at the exposure position P while the film 15 is passing the exposure unit 40, and thereafter the exposed film 15a is heated by the heating unit 50. The distance PH between the exposure position P and the heat start position H is shorter than the length of the film 15 in the delivery (carrying) direction. Consequently, one film 15 being carried can be exposed to the laser light in the exposure unit 40 and heated in the heating unit 50 simultaneously.

The film 15, which has been extracted from the film supply cassette 14, is carried along a substantially U-shaped carrying path and stored in the film collection tray 16. During carrying, the rear tip of the film 15 is exposed to the light at the same time as the front tip, which was exposed to the light a moment earlier, is being heated. The film supply cassette 14 and the film collection tray 16 correspond to opposite sides of the two ends of the U-shaped carrying path, and the processes of exposure and heating are performed on a curved bottom face which connects them.

In comparison with the conventional apparatus, where the processes of exposure and heating are performed at separate positions, the constitution described above enables the carrying path to be made as short as possible, with a consequent flatness regain in the number of carrying rollers 31 which comprise the carrying unit 30. Therefore, the dry processor 10 can more easily be made small and light, and the number of components can be reduced.

The heating unit 50 of this invention has a film passage 53 between the heating blocks 51 and 52, arranged on both sides of the film 15. Each of the heating blocks 51 and 52 contains a heater 54, enabling the exposed film 15a which passes through the film passage 53 to be heated from both sides.

The heating unit 50 is set so that the temperature distribution along the width of the exposed film 15a and the heating distance along the delivery direction of the exposed film 15a are uniform. More specifically, the heaters 54 inside the blocks 51 and 52 comprise rod-like blocks, arranged at right angles to the carrying direction of the exposed film 15a, i.e. parallel to the width of the exposed film 15a.

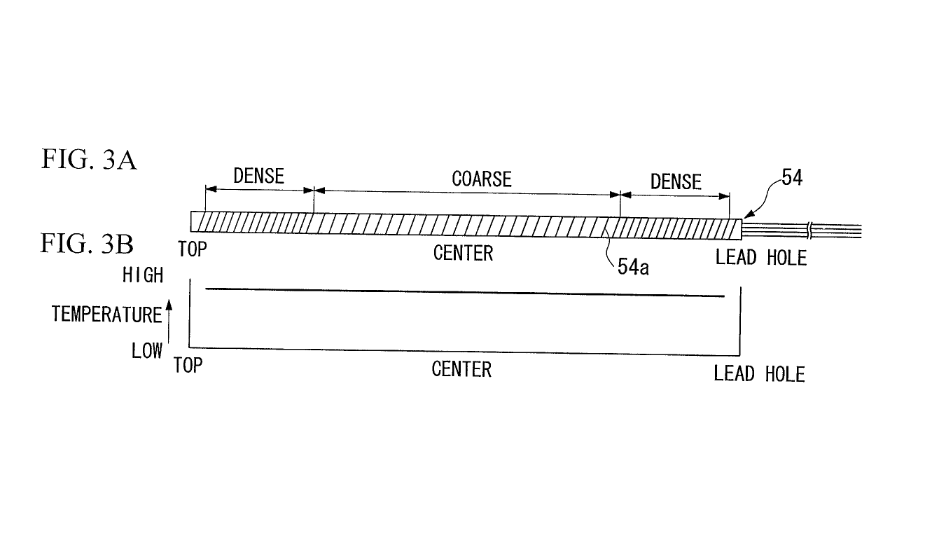

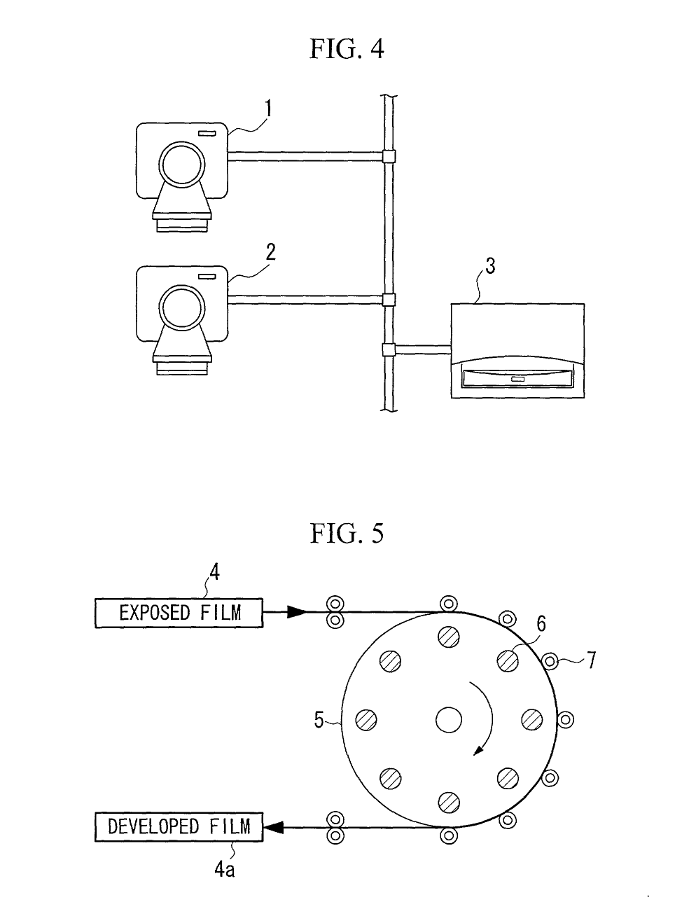

FIG. 3A shows an example of the constitution of the heater 54, and FIG. 3B shows heating temperature distribution characteristics thereof. The temperature distribution of the heater 54 in the axial direction is kept constant by adjusting the number of windings (winding intensity) of a heater element 54a, the winding intensity being made coarse in the center and more intense toward the two ends. As a result, the temperature distribution of the heater 54 is constant in the axial direction.

Therefore, when the heaters 54 are provided inside the heating blocks 51 and 52 in such a manner that the axial direction of the heaters 54 is parallel to the width of the exposed film 15a, the temperature distribution of the heating blocks 51 and 52 can be made constant in the width direction. By providing the film passage 53 so that the carrying distance is the same at any position in the width direction of the exposed film 15a, the exposed film 15a can be heated at the same temperature for the same length of time. Therefore, the heat quantity, obtained by multiplying the temperature by time, is constant across the entire surface of the exposed film 15a. Since the heating distance can easily be kept constant by adjusting the carrying distance, and the temperature distribution can easily be kept constant by adjusting the element wind intensity of the heaters 54, the temperature of the heating unit 50 of the dry processor can be controlled with extreme ease.

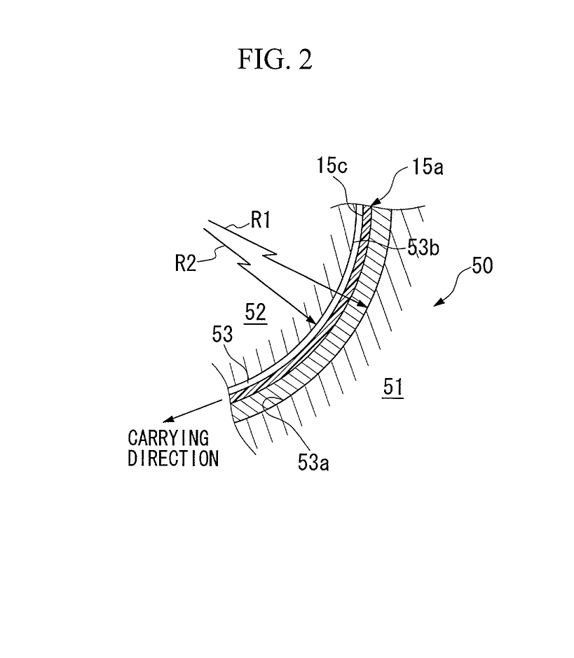

In this invention, the film passage 53 has a large curvature on the emulsion face side of the film 15. Explained more specifically based on FIG. 2, one side of the film 15 comprises an emulsion face 15c having a large curvature. In the example shown in FIG. 2, the exposed film 15a is carried so that its emulsion face 15c faces the heating block 52. In this case, when R1 represents the radius of curvature of the surface 53a of one heating block 51 which forms the film passage 53, and R2 represents the radius of curvature of the surface 53b of the other heating block 52, R1>R2. Therefore, the surface 53a of the heating block 51 curves more gently than the surface 53b of the heating block 52.

When this type of film passage 53 is provided, the elasticity of the film 15 itself causes the emulsion face 15c, which affects the density of the image, to be carried away from the surface 53b, creating a gap. This prevents damage to the emulsion face 15c and enables a superior image to be provided.

The film passage 53 should preferably be formed by two fluororesin (Teflon™) coated opposing faces 53a and 53b having a constant width therebetween. The constant width of this type of film passage 53 allows the exposed film 15a to be carried smoothly through without snagging and the like, and also prevents damage to the film surface contacting the surface 53a which is opposite the emulsion face 15c, and damage when the emulsion face 15c has contacted the surface 53.

In this embodiment, a cooling region 60 comprising a carrying distance L is provided at the exit of the heating unit 50, and the flatness regain rollers 70 are provided after the cooling region 60. The developed film 15b, which has exited the heating unit 50 and is still at a high temperature, is moderately cooled during the carrying distance L, and warping of the film can be prevented by stretching the developed film 15b in this state.

Due to a problem that the sensitivity characteristics of the films 15 vary slightly from lot to lot, the laser light output of the exposure unit 40 must be adjusted appropriately in order to stably supply high-quality gray-scale images at all times. Accordingly, the dry processor 10 of this invention has a density level detecting unit 80, which is provided near the exit of the heating unit 50, and the exposure unit is controlled based on feedback from the density level detecting unit 80.

The density level detecting unit 80 detects the density of the developed film 15b which has been processed through the heating unit 50, and outputs the detected value to the control section 13. The control section 13 compares the detected value with pre-stored data, and adjusts the output of the laser light from the laser unit 41 accordingly. By adjusting the laser light in this manner, the density of the images can be supplemented by feedback control, thereby achieving images having a stable density level.

The present invention is not limited to the em described above, and various modifications can be made within the scope of the main concepts of the invention.

According to the dry gray-scale image processor of this invention, the processes of exposure and heating can be performed in parallel simultaneously while the film is being carried along the substantially U-shaped carrying path. Therefore, by minimizing the carrying distance for the film, the number of components and the passage space can be reduced, enabling the processor to be made small, light, and inexpensive.

Further, it is not necessary to control the temperature of the heating unit so that all heating surfaces are constant; the temperature need only be made constant along a line which intersects at a right angle with the carrying direction of the film. Therefore, it is extremely easy to control the temperature of the heating unit, thereby preventing undesired variation in heat-developing and obtaining superior gray-scale images. When temperature control is made easier in this way, the cost can be reduced.

Further, since the film is heated while being carried, the apparatus is highly versatile, and one apparatus can be used to heat-develop films of widely varying sizes.

What is claimed is:

1. A dry gray-scale image processor which extracts unexposed films one by one and carries them to an exposure unit, radiates a laser beam comprising an image data signal onto the film as it passes said exposure unit, and develops the exposed film by heating it at a heating unit, wherein
an interval between an exposure position of said exposure unit and a heat start position of said heating unit is shorter than the length of the film in the delivery direction, and the exposure process and heating process are performed in parallel simultaneously.

2. A dry gray-scale image processor as described in claim 1, wherein said heating unit comprises a film passage, provided between heating blocks which are arranged on either side of said film.

3. A dry gray-scale image processor as described in claim 1, wherein said heating unit is set so that the temperature distribution along the width of said film and the heating distance along the delivery direction of said film are uniform.

4. A dry gray-scale image processor as described in claim 2, wherein said heating unit is set so that the temperature distribution along the width of said film and the heating distance along the delivery direction of said film are uniform.

5. A dry gray-scale image processor as described in claim 1, wherein said film passage has a large curvature with respect to the emulsion face side of said film.

6. A dry gray-scale image processor as described in claim 2, wherein said film passage has a large curvature with respect to the emulsion face side of said film.

7. A dry gray-scale image processor as described in claim 3, wherein said film passage has a large curvature with respect to the emulsion face side of said film.

8. A dry gray-scale image processor as described in claim 4, wherein said film passage has a large curvature with respect to the emulsion face side of said film.

9. A dry gray-scale image processor as described in claim 5, wherein the film passage comprises two fluororesin coated opposing faces having a constant width therebetween.

10. A dry gray-scale image processor as described in claim 6, wherein the film passage comprises two fluororesin coated opposing faces having a constant width therebetween.

11. A dry gray-scale image processor as described in claim 7, wherein the film passage comprises two fluororesin coated opposing faces having a constant width therebetween.

12. A dry gray-scale image processor as described in claim 8, wherein the film passage comprises two fluororesin coated opposing faces having a constant width therebetween.

13. A dry gray-scale image processor as described in claim 1, wherein a density level detecting unit is provided near the exit of said heating unit, and said exposure unit is controlled by feedback.

14. A dry gray-scale image processor as described in claim 2, wherein a density level detecting unit is provided near the exit of said heating unit, and said exposure unit is controlled by feedback.

15. A dry gray-scale image processor as described in claim 3, wherein a density level detecting unit is provided near the exit of said heating unit, and said exposure unit is controlled by feedback.

16. A dry gray-scale image processor as described in claim 4, wherein a density level detecting unit is provided near the exit of said heating unit, and said exposure unit is controlled by feedback.

17. A dry gray-scale image processor as described in claim 5, wherein a density level detecting unit is provided near the exit of said heating unit, and said exposure unit is controlled by feedback.

18. A dry gray-scale image processor as described in claim 6, wherein a density level detecting unit is provided near the exit of said heating unit, and said exposure unit is controlled by feedback.

19. A dry gray-scale image processor as described in claim 7, wherein a density level detecting unit is provided near the exit of said heating unit, and said exposure unit is controlled by feedback.

20. A dry gray-scale image processor as described in claim 8, wherein a density level detecting unit is provided near the exit of said heating unit, and said exposure unit is controlled by feedback.

21. A dry gray-scale image processor as described in claim 9, wherein a density level detecting unit is provided near the exit of said heating unit, and said exposure unit is controlled by feedback.

22. A dry gray-scale image processor as described in claim 10, wherein a density level detecting unit is provided near the exit of said heating unit, and said exposure unit is controlled by feedback.

23. A dry gray-scale image processor as described in claim 11, wherein a density level detecting unit is provided near the exit of said heating unit, and said exposure unit is controlled by feedback.

24. A dry gray-scale image processor as described in claim 12, wherein a density level detecting unit is provided near the exit of said heating unit, and said exposure unit is controlled by feedback.

25. A dry gray-scale image processor as described in one of claims 1 to 24, wherein flatness regain rollers are provided at the exit of said heating unit with a cooling region therebetween.
